(19) United States
(12) Patent Application Publication
(10) Pub. No.: US 2012/0262799 A1
(43) Pub. Date: Oct. 18, 2012

(54) ZOOM LENS

(75) Inventor: Hsiang-Ho Chou, TAIPEI (TW)

(73) Assignee: ABILITY ENTERPRISE CO., LTD., TAIPEI (TW)

(21) Appl. No.: 13/347,453

(22) Filed: Jan. 10, 2012

(30) Foreign Application Priority Data
Apr. 12, 2011 (TW) 100112664

(51) Int. Cl. G02B 15/14

(52) U.S. Cl. 359/684; 359/683

(57) ABSTRACT

An embodiment of this invention provides a zoom lens, which includes, in order from an object side to an image-forming side, a first lens group having positive refractive power, a second lens group having negative refractive power, a third lens group having positive refractive power, a fourth lens group having positive refractive power, and a fifth lens group having negative refractive power, wherein the second lens group, the fourth lens group, and the fifth lens group are moving with respect to one another, for zooming from a wide-angle end to a telephoto end thereof.

### CROSS-REFERENCE TO RELATED APPLICATIONS

The entire contents of Taiwan Patent Application No, 100112664, filed on Apr. 12, 2011, from which this application claims priority, are incorporated herein by reference.

### BACKGROUND OF THE INVENTION

1. Field of the Invention

The present invention relates to zoom lenses, especially to zoom lenses with low cost, high zoom ratio, compact size, and good image quality.

2. Description of Related Art

Image-capturing devices, such as digital cameras or digital camcorders, employ a zoom lens and an image sensor to collect an image beam of an object, in which the zoom lens focuses the image beam on the image sensor, which then turns the image beam into digital signals for following processing, transmitting, and storage.

Typically, the zoom lens of the image-capturing devices consists of several lenses. To offer competitive price and lower the weight, one or more plastic lenses are employed in the zoom lens; however, the plastic lenses come with the disadvantages of moisture and light absorption, and conflict may appear between small size, high zoom ratio, and well image quality when reducing the cost.

Therefore, it would be advantageous to provide a novel zoom lens having advantages of compact size, high zoom ratio, and good image quality when reducing the cost.

### SUMMARY OF THE INVENTION

An object of the present invention is to provide novel zoom lenses having advantages of compact: size, high zoom ratio, good image quality, and low cost.

Accordingly, one embodiment of this invention provides a zoom lens that primarily comprises, in order from an object side to an image-forming side, a first lens group having positive refractive power, a second lens group having negative refractive power, a third lens group having positive refractive power, a fourth lens group having positive refractive power, and a fifth lens group having negative refractive power, wherein the second lens group, the fourth lens group, and the fifth lens group are moved with respect to one another for zooming between a wide-angle end and a telephoto end.

By the features described above, the zoom lens of this invention has better image quality than conventional ones under the conditions of compact size and low cost.

### BRIEF DESCRIPTION OF THE DRAWINGS

FIG. 1A and FIG. 1B respectively show a zoom lens at the wide-angle end and the telephoto end, according to a preferred embodiment of this invention.

FIGS. 2A and 2B respectively show the longitudinal spherical aberration chart of the zoom lens at the wide-angle end and the telephoto end, according to an example of this invention.

FIGS. 3A and 3B respectively show the astigmatism chart of the zoom lens at the wide-angle end and the telephoto end, according to an example of this invention.

FIGS. 4A and 4B respectively show the distortion chart of the zoom lens at the wide-angle end and the telephoto end, according to an example of this invention.

### DESCRIPTION OF THE PREFERRED EMBODIMENT

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known components and process operations are not described in detail in order not to unnecessarily obscure the present invention. While drawings are illustrated in detail, it is appreciated that the quantity of the disclosed components may be greater or less than that disclosed, except where expressly restricting the amount of the components.

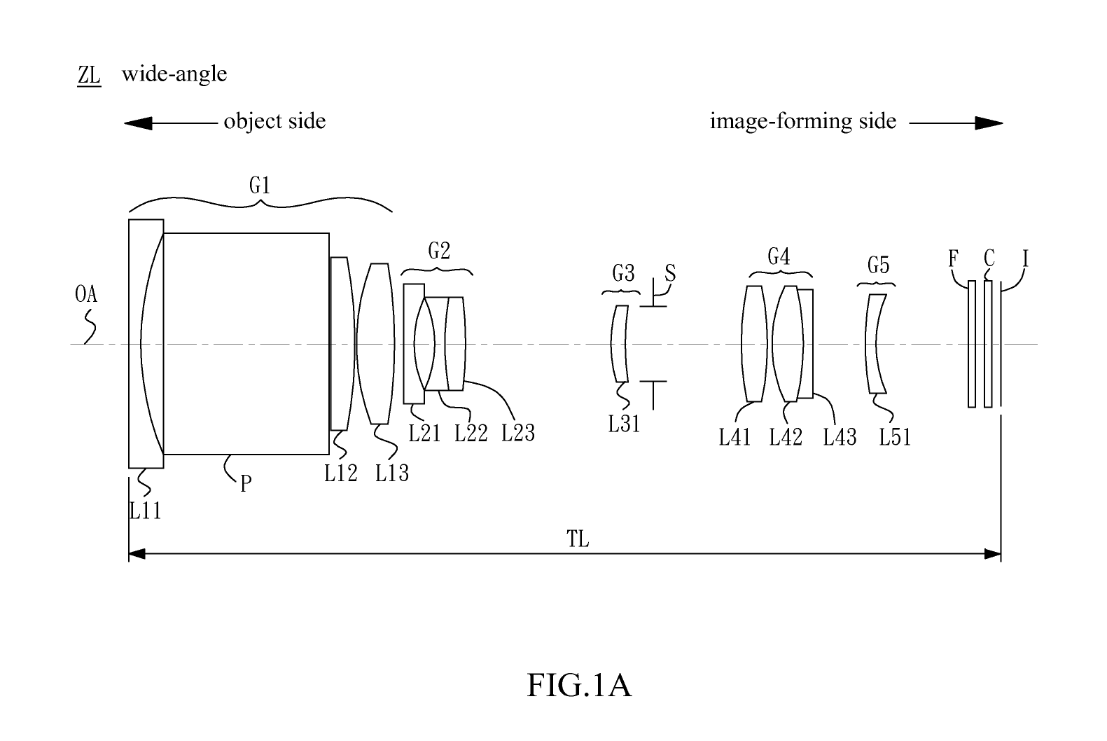

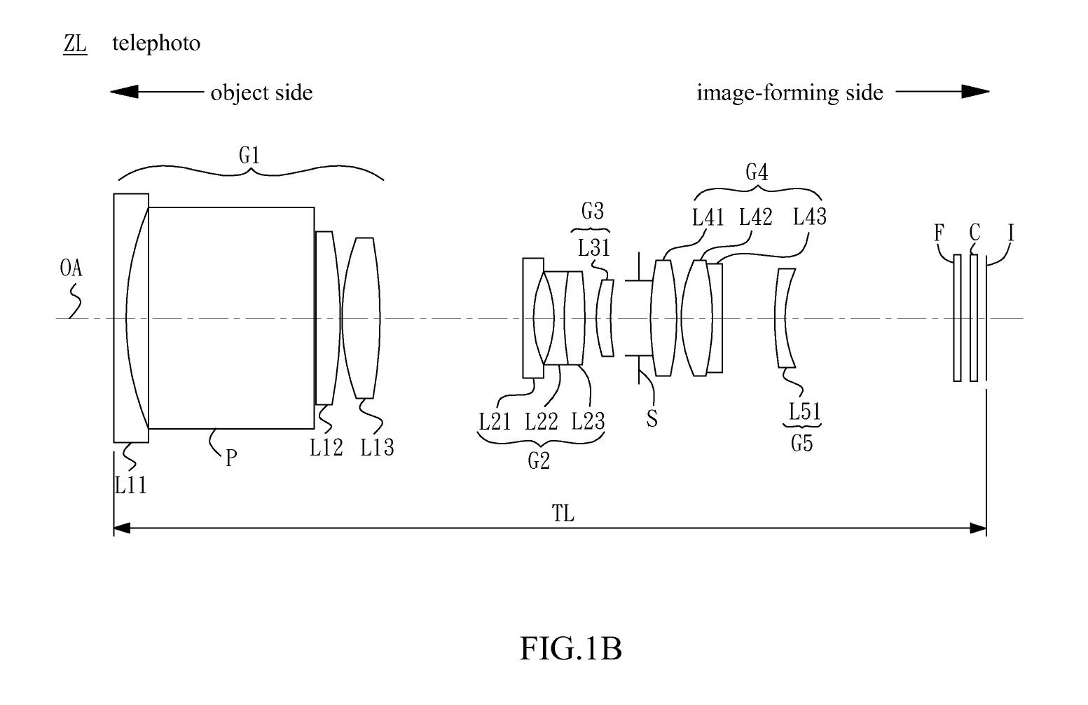

FIG. 1A and FIG. 1B show a zoom lens ZL according to a preferred embodiment of this invention, wherein FIG. 1A shows the position of every lens in the wide-angle end and FIG. 1B shows the position of every lens in the telephoto end. To highlight features of the zoom lens ZL, the drawings merely show related components of this embodiment, and omit other irrelevant or minor components. The zoom lens illustrated by this embodiment may be employed in an image-capturing device, such as a digital camera, a digital camcorder, a cellular phone, or a projector.

As shown in FIG. 1A and FIG. 1B, the zoom lens ZL primarily consists of, in order from an object side to an image-forming side, a first lens group G1, a second lens group G2, a third lens group G3, a fourth lens group G4, and a fifth lens group G5. The first lens group G1 has positive refractive power, the second lens group G2 has negative refractive power, the third lens group G3 has positive refractive power, the fourth lens group G4 has positive refractive power, and the fifth lens group G5 has negative refractive power.

For needs of compact size, low cost, high zoom ratio, and good image quality, the zoom lens ZL satisfies the following conditions:

4.0<ft/fw<6.0; (1)

and

2.0<|fG1/fG2|<4.0, (2)

wherein fG1 denotes the focal length of the first lens group G1, fG2 denotes the focal length of the second lens group G2, fw denotes the focal length of the zoom lens ZL at the wide-angle end, and ft denotes the focal length of the zoom lens ZL at the telephoto end.

As shown in FIG. 1A and FIG. 1B, the zoom lens ZL may further comprise an optical axis OA, a stop S, and a filter F. The stop S may be arranged between the third lens group G3 and the fourth lens group G4, for limiting the light flux of the image beam into the fourth lens group G4 and making the image beam more symmetric. The filter F may be arranged between the fifth lens group G5 and an image-forming plane 1, for filtering invisible light off the image beam. The filter F may be an infrared light filter. The image-forming plane denotes an image-capturing unit having light-to-electricity conversion function, for receiving image beam passing through the filter F. In addition, a flat lens C, as a cover glass, may be arranged between the image-forming plane 1 and the filter F.

In this embodiment, when zooming between the wide-angle end and the telephoto end, the positions of the first lens group G1, the third lens group G3, and the stop S will be kept, and the second lens group G2, the fourth lens group G4, and the fifth lens group G5 are relatively moved along the optical axis OA with one another, so as to determine a zoom ratio. In detail, when zooming from the wide-angle end to the telephoto end, the second lens group G2, the fourth lens group G4, and the fifth lens group G5 are moved toward the third lens group G3.

Referring to FIG. 1A and FIG. 1B again, the zoom lens ZL at least comprises four aspheric lenses or free-form lenses made of optical material, such as plastic or glass. In this embodiment, the first lens group G1, the second lens group G2, the third lens group G3, and the fifth lens group G5 respectively comprise an aspheric lens or a free-form lens made of plastic. In other words, each of the foregoing groups, groups G1, G2, G3, and G5, respectively comprise an aspheric plastic lens or a free-form plastic lens.

The plastic may comprise, but is not limited to, resins or polymers, such as polycarbonate, cyclic olefin copolymer (e.g. APEL), polyester resins (e.g. OKP4 or OKP4HT), and the like. In addition, each free-form lens has at least one free-form surface, and each aspheric lens has at least one aspheric surface satisfying the following equation (3):

$$Z = \frac{C {Y}^{2}}{1 + \sqrt{1 - ( K + 1 ) {C}^{2} {Y}^{2}}} + {A}_{4} {Y}^{4} + {A}_{6} {Y}^{6} + {A}_{8} {Y}^{8} + {A}_{10} {Y}^{10} + {A}_{12} {Y}^{12} ,$$

where Z is the coordinate in the optical axis OA direction in which direction light propagates as positive, A₄, A₆, A₈, A₁₀, and A₁₂ are aspheric coefficients, K is coefficient of quadratic surface, R is the radius of curvature, C is reciprocal of R (C=1/R, Y is the coordinate in a direction perpendicular to the optical axis in which the upward direction is positive, and coefficients of equation (3) of each aspheric lens are predetermined to determine the focal length and thus satisfy the above-mentioned conditions.

In this preferred embodiment, the first lens group G1 comprises, in order from the object side to the image-forming side, a first lens L11, a second lens L12, a third lens L13, in which the first lens L11 has negative refractive power, the second lens L12 has positive refractive power, and the third lens L13 has positive refractive power. The second lens group G2 comprises, in order from the object side to the image-forming side, a first lens L21, a second lens L22, a third lens L23, in which the first lens L21 has negative refractive power, the second lens L22 has negative refractive power, and the third lens L23 has positive refractive power. The third lens group G3 comprises a first lens L31 having positive refractive power. The fourth lens group G4 comprises, in order from the object side to the image-forming side, a first lens L41, a second lens L42, and a third lens L43, in which the first lens L41 has positive refractive power, the second lens L42 has positive refractive power, and the third lens L43 has negative refractive power. The fifth lens group G5 comprises a first lens L51 having negative refractive power.

In addition, the zoom lens ZL may further comprise a reflector for deflecting the direction of the image beam, e.g. deflecting the direction of the image beam by 90°. In this preferred embodiment, the reflector is a prism P, arranged between the first lens L11 and the second lens L12 of the first lens group G1, for deflecting the optical path of the image beam and shortening the total length of the zoom lens ZL. The prism P may be arranged in other positions in other embodiments of this invention. In addition, the reflector may be a mirror or other components known in the art.

In addition, in this preferred embodiment, the zoom lens ZL may further satisfy the following condition:

1.5<PL/fw<2.2 (4)

wherein PL denotes the optical path length of the prism P for deflecting the image beam, i.e. the optical path length of the image beam within the prism. In another embodiment, condition (4) may be modified as 1.75<PL/fw<2.0.

It is appreciated that, preferably, the third lens L13 of the first lens group G1, the first lens L21 of the second group G2, and the first lens L31 of the third lens group G3, the first lens L51 of the fifth lens group G5, may be aspheric plastic lenses with two aspheric surfaces, and other lenses of the zoom lens may be spherical glass lenses with two spherical surfaces. In addition, the second lens L22 and the third lens L23 of the second lens group G2, and the second lens L42 and the third lens L43 of the fourth lens group (34, may be glued to be a doublet lens.

A polish or a glass molding process (GMP), using an optical grade glass material, may be used to fabricate the glass lenses, and an injection molding process, using a polymer as the material, may be used to fabricate the plastic lenses.

Table 1 lists the detail information of the zoom lens ZL shown in FIG. 1, according to an example of this invention. The information includes the curvature radius, the thickness, the refractive index, and the Abbe number of lenses or every surface of lenses in the zoom lens, where the surface numbers are sequentially ordered from the object side to the image-forming side. For example, “S1” stands for the surface of the first lens L11 facing the object side, “S2” stands for the surface of the first lens L12 facing the image-forming side, “S3” stands for the surface of the prism P facing the object side, “S25” and “S26” respectively stands for the surface of the filter F facing the object side and the image-forming side, “S27” and “S28” respectively stands for the surface of the flat lens C facing the object side and the image-forming side, and so on.

TABLE 1

| lens | Surface | curvature radius | thickness | refractive | |
|---|---|---|---|---|---|
| No. | No. | (mm) | (mm) | index | Abbe no. |
| L11 | S1 | −300.000 | 0.7 | 2.0006 | 25.458 |
| | S2 | 17.878 | 1.37 | | |
| P | S3 | ∞ | 10 | 1.846663 | 23.78 |
| | S4 | ∞ | 0.054 | | |
| L12 | S5 | ∞ | 1.385 | 1.496997 | 81.61 |
| | S6 | −24.831 | 0.1 | | |
| L13 | S7 | 12.130 | 2.4 | 1.544 | 56.11 |
| | S8 | −23.270 | D1 | | |
| L21 | S9 | −35.291 | 0.65 | 1.544 | 56.11 |
| | S10 | 7.159 | 1.3 | | |
| L22 | S11 | −8.426 | 0.55 | 1.882997 | 40.76 |
| | S12 | 18.551 | 0 | | |
| L23 | S13 | 18.551 | 1.15 | 1.945945 | 17.98 |
| | S14 | −30.150 | D2 | | |
| L31 | S15 | 7.248 | 0.99 | 1.544 | 56.11 |
| | S16 | 16.912 | 0.8 | | |
| | S | ∞ | D3 | | |
| L41 | S17 | 16.900 | 1.6 | 1.496997 | 81.61 |
| | S18 | −12.657 | 0.1 | | |
| L42 | S19 | 7.652 | 1.99 | 1.496997 | 81.61 |
| | S20 | −14.000 | 0 | | |
| L43 | S21 | −14.000 | 0.55 | 2.0006 | 25.458 |
| | S22 | 83.005 | D4 | | |
| L51 | S23 | 17.112 | 0.6 | 1.544 | 56.11 |
| | S24 | 6.943 | D5 | | |
| F | S25 | ∞ | 0.3 | 1.51633 | 64.14 |
| | S26 | ∞ | 0.4 | | |
| C | S27 | ∞ | 0.5 | 1.51633 | 64.14 |
| | S28 | ∞ | 0.8 | | |
| | I | ∞ | | | |

In Table 1, the “thickness” stands for the distance between the indicated surface and the next. For example, the thickness of the surface S1 is the distance between the surface S1 and the surface S2, and the thickness of the surface S2 is the distance between the surface S2 and the surface S3. In addition, the thickness labeled with D1, D2, D3, D4, or D5 indicates that the thickness is a variable depending on the wide-angle end or the telephoto end, and Table 2 lists the detail.

TABLE 2

| thickness | Wide-angle end (mm) | Telephoto end (mm) |
|---|---|---|
| D1 | 0.5277 | 8.8734 |
| D2 | 8.8457 | 0.5 |
| D3 | 6.1 | 1.01 |
| D4 | 3.2456 | 2.1172 |
| D5 | 5.5 | 11.8093 |

Besides, Table 3 lists the focal length f, the aperture FNO (F-number), the half angle view ω, the image height Y, and the total length TL of the zoom lens in this example,

TABLE 3

| Parameters | Wide-angle end | Telephoto end |
|---|---|---|
| F (mm) | 5.1 | 24.1 |
| FNO | 4.00 | 5.83 |
| ω (°) | 40.2245 | 9.38343 |
| Y (mm) | 3.6 | 4.0 |
| TL (mm) | 52.599 | 52.5989 |

Furthermore, in this example, the third lens L13, the first lens L21, the first lens L31, and the first lens L51 are aspheric lenses, and the surfaces S7, S8, S9, S10, S15, S16, S23, and S24 are aspheric surfaces. The aspheric coefficients of the aspheric surfaces are listed in Table 4.

TABLE 4

| | K | A₄ | A₆ | A₈ | A₁₀ | A₁₂ |
|---|---|---|---|---|---|---|
| S7 | 0 | −4.68481E−05 | −5.80495E−07 | 2.0736E−08 | −3.69926E−10 | 0 |
| S8 | 0 | 5.5089E−05 | −6.20553E−07 | 3.1739E−08 | −5.6766E−10 | 0 |
| S9 | 0 | 0.001548991 | −0.000143 | 1.084E−05 | −4.32513E−07 | 6.04529E−09 |
| S10 | 0 | 0.001429906 | −9.80435E−05 | 1.3217E−06 | 1.09913E−06 | −7.33956E−08 |
| S15 | 0 | 0.000618876 | 1.97261E−05 | −3.701E−06 | −2.88921E−08 | 0 |
| S16 | 0 | −0.00017483 | 7.72607E−06 | −4.78E−07 | −3.37063E−07 | 0 |
| S25 | 0 | 0.000811173 | 0.000144437 | −2.714E−05 | 1.47852E−06 | 4.71652E−09 |
| S26 | 0 | 0.000149341 | 0.000147094 | −2.00E−05 | −2.10229E−07 | 1.23686E−07 |

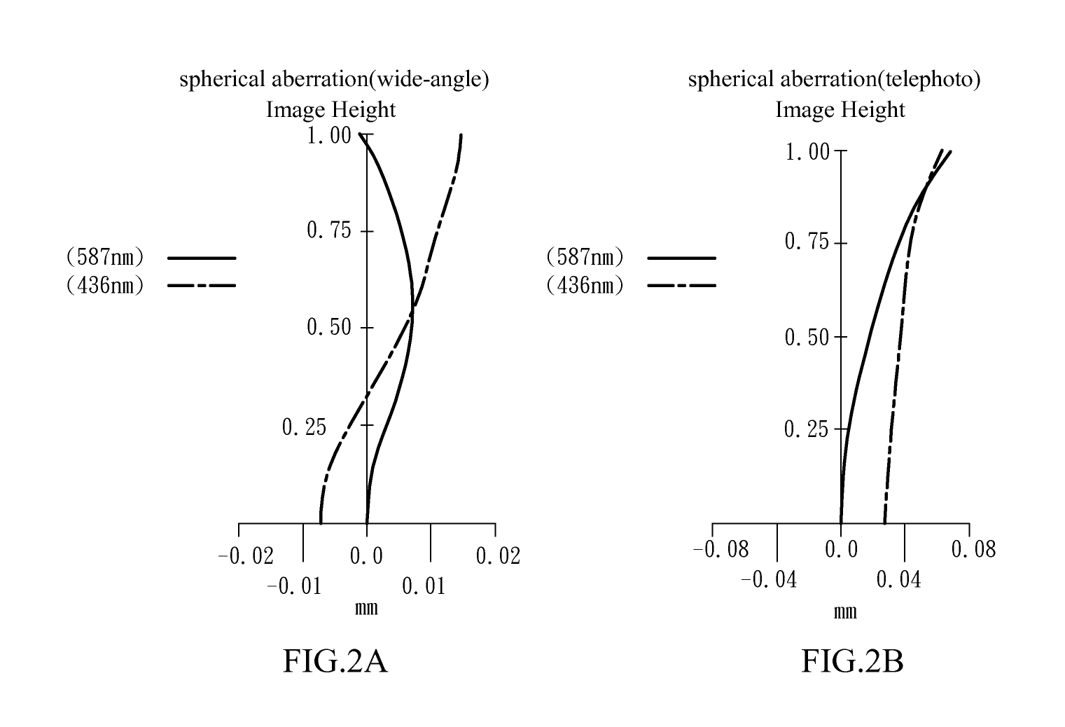

FIGS. 2A and 2B respectively show the longitudinal spherical aberration chart of the zoom lens at the wide-angle end and the telephoto end, according to an embodiment of this invention. The charts show that for image beams with wavelength 436 and 587 nm, the spherical aberrations are less than 0.004 mm and 0.015 mm at the wide-angle end respectively, and less than 0.03 mm and 0.05 mm at the telephoto end respectively.

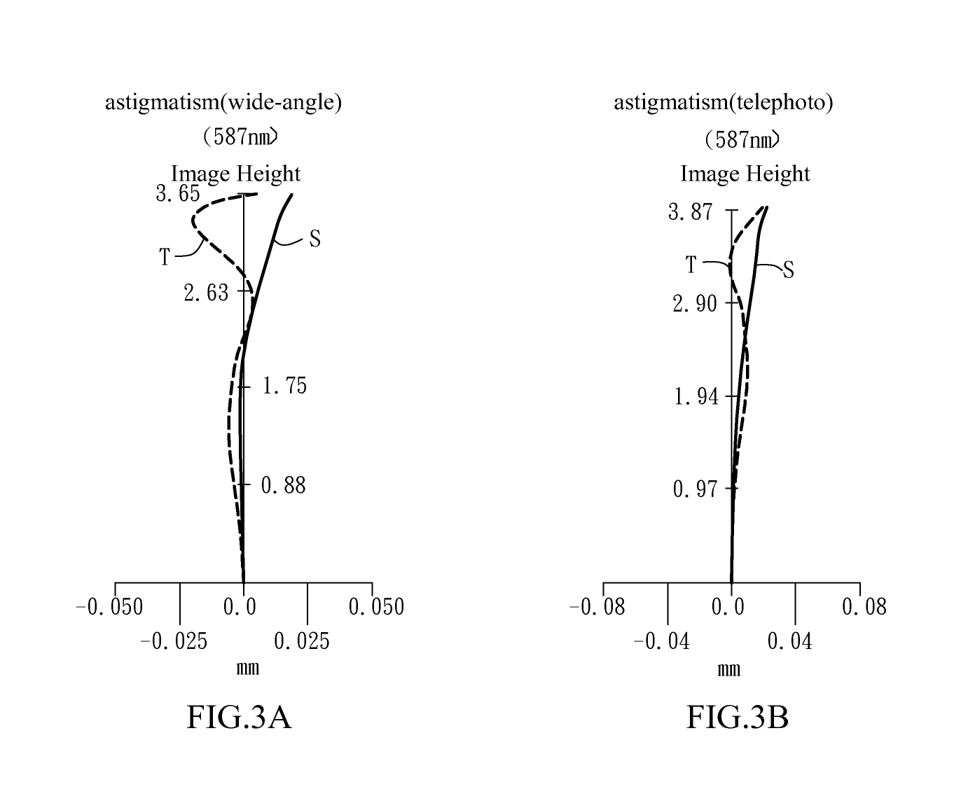

FIGS. 3A and 3B respectively show the astigmatism chart of the zoom lens at the wide-angle end and the telephoto end, according to an example of this invention. Where curve T and S stand for the aberration of the zoom lens to the tangential rays and the sagittal rays for an image beam with wavelength 587 nm; in the wide angle end, S (i.e. tangential value) and T (i.e. sagittal value) are both set in the range of (−0.025 mm, 0.025 mm); in the telephoto end, S and T are both set in the range of (−0.04 mm, 0.04 mm).

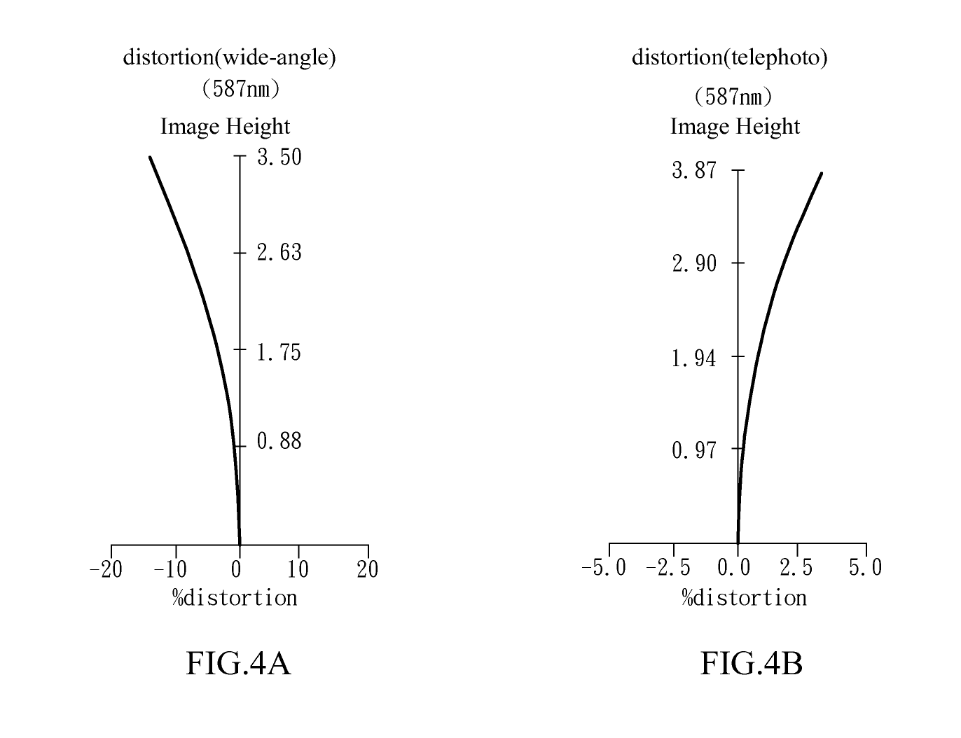

FIGS. 4A and 4B respectively show the distortion chart of the zoom lens at the wide-angle end and the telephoto end, according to an example of this invention. As shown in the drawings, in the wide-angle end the distortion value for image beam with wavelength 587 nm is set in the range of (−14.5%, 0%) while (0%, 2%) in the telephoto end.

The results from FIGS. 2A to 4B show that the spherical aberration, astigmatism, and distortion of the zoom lens can be properly adjusted. Therefore, under the conditions of compact size and low cost, embodiments of the present invention provide zoom lenses having better image quality and higher zoom ratio than conventional ones.

Although specific embodiments have been illustrated and described, it will be appreciated by those skilled in the art that various modifications may be made without departing from the scope of the present invention, which is intended to be limited solely by the appended claims.

What is claimed is:

1. A zoom lens, in order from an object side, comprising:
a first lens group having positive refractive power;
a second lens group having negative refractive power;
a third lens group having positive refractive power;
a fourth lens group having positive refractive power; and
a fifth lens group having negative refractive power;
wherein the second lens group, the fourth lens group, and the fifth lens group are relatively moved with each other, for zooming between a wide-angle end and a telephoto end.

2. The zoom lens as recited in claim 1, wherein the zoom lens satisfies the following condition: 4.0<ft/fw<6.0,
wherein, fw is a focal length of the zoom lens at the wide-angle end, and ft is a focal length of the zoom lens at the telephoto end.

3. The zoom lens as recited in claim 1, wherein the zoom lens satisfies the following condition: 2.0<|fG1/fG2|<4.0,
wherein, fG1 is a focal length of the first lens group, and fG2 is a focal length of the second lens group.

4. The zoom lens as recited in claim 1, wherein the second lens group, the fourth lens group and the fifth lens group are relatively moved toward the third lens group, so that the zoom lens focuses from the wide-angle end to the telephoto end.

5. The zoom lens as recited in claim 1, wherein the first lens group, the second lens group, the third lens group and the fifth lens group respectively comprise at least one aspheric lens or free-form lens.

6. The zoom lens as recited in claim 1, wherein the first lens group, the second lens group, the third lens group and the fifth lens group respectively comprise at least one plastic lens.

7. The zoom lens as recited in claim 1, wherein the first lens group comprises, in order from the object side to an image-forming side, a first lens having negative refractive power, a second lens having positive refractive power and a third lens having positive refractive power.

8. The zoom lens as recited in claim 7, wherein the first lens group further comprises a reflector.

9. The zoom lens as recited in claim 8, wherein the reflector is a prism, and the zoom lens satisfies the following condition: 1.5<PL/fw<2.2,
wherein, PL is an optical path length of incident beams within the prism, and fw is a focal length of the zoom lens at the wide-angle end.

10. The zoom lens as recited in claim 9, wherein the prism is disposed between the first lens and the second lens.

11. The zoom lens as recited in claim 7, wherein the third lens is an aspheric lens, a free-form lens or a plastic lens.

12. The zoom lens as recited in claim 1, wherein the second lens group comprises, in order from the object side to an image-forming side, a first lens having negative refractive power, a second lens having negative refractive power and a third lens having positive refractive power.

13. The zoom lens as recited in claim 12, wherein the first lens is an aspheric lens, a free-form lens or a plastic lens.

14. The zoom lens as recited in claim 12, wherein the second lens and the third lens are glued to be a doublet lens.

15. The zoom lens as recited in claim 1, wherein the fourth lens group comprises, in order from the object side to an image-forming side, a first lens having positive refractive power, a second lens having positive refractive power and a third lens having negative refractive power.

16. The zoom lens as recited in claim 15, wherein the second lens and the third lens are glued to be a doublet lens.

17. The zoom lens as recited in claim 1, wherein the third lens group comprises a first lens having positive refractive power, and the fifth lens group comprises a first lens having negative refractive power.

18. The zoom lens as recited in claim 17, wherein both the first lens of the third lens group and the first lens of the fifth lens group are aspheric lenses, free-form lenses or plastic lenses.

19. The zoom lens as recited in claim 1, further comprising a stop disposed between the third lens group and the fourth lens group.

20. The zoom lens as recited in claim 1, further comprising a filter disposed between the fifth lens group and an image-forming plane of the zoom lens.
